(19) United States
(12) Patent Application Publication
(10) Pub. No.: US 2026/0146494 A1
(43) Pub. Date: May 28, 2026

(54) WATER AND FIRE RESISTANT GASKET

(71) Applicant: Lorient North America Ltd., Lexington, KY (US)

(72) Inventors: Terry Agee, Somerset, PA (US); Kristy Jones, Morehead, KY (US)

(73) Assignee: Lorient North America Ltd., Lexington, KY (US)

(21) Appl. No.: 19/381,628

(22) Filed: Nov. 6, 2025

Related U.S. Application Data
(60) Provisional application No. 63/725,188, filed on Nov. 26, 2024.

(51) Int. Cl. E06B 7/23

(52) U.S. Cl. CPC E06B 7/2318

(57) ABSTRACT

A gasket configured to resist infiltration of smoke, water, and fire is disclosed, along with methods of manufacture of said gasket. The gasket may at least partially seal gaps in its unexpanded state to resist infiltration of smoke and water. The gasket may be configured to expand when exposed to temperatures above a threshold temperature to additionally resist infiltration of fire.

### CROSS-REFERENCE TO RELATED APPLICATIONS

This application claims the benefit of priority under 35 U.S.C. § 119(e) to U.S. Provisional Application Ser. No. 63/725,188 filed on Nov. 26, 2024, which is hereby incorporated by reference in its entirety.

### FIELD

The field generally relates to gaskets used to establish seals.

### BACKGROUND

When a door is in a closed position, a gap may exist around the door which may allow smoke, fire, and water to bypass the door. While many doors are constructed with fire-resistant walls to reduce damage to contents inside due to fire and heat, gaps around the door may allow fire and smoke to bypass the door. Some contemporary doors use gaskets to seal a perimeter around the door that restricts the spread of fire and smoke through gaps between sides of the door and a door jamb. In addition to sealing out fire and smoke, some doors utilize a separate gasket to limit water infiltration through gaps around the door.

### SUMMARY

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In some embodiments, a gasket may be configured to attach to a side of a door jamb or a side of a door. The gasket may comprise a foam portion comprising an intumescent material configured to expand when exposed to a temperature above a threshold temperature. The foam portion may comprise a base surface configured to contact one of the side of the door jamb or the side of the door and at least one fin configured to contact the other of the side of the door jamb or the side of the door when the door is closed to at least partially seal a gap between the side of the door jamb and the side of the door when the door is closed. The foam portion may be configured to resist intrusion of smoke and water through the gap when the foam portion is unexpanded. The foam portion may be further configured to resist intrusion of fire, smoke, and water when the foam portion is expanded. The gasket may comprise an intermediate portion attached to the foam portion adjacent to the base surface. The intermediate portion may be formed of a different material than the foam portion. The gasket may further comprise an adhesive applied to the intermediate portion configured to attach the gasket to the side of the door jamb or the side of the door.

In some embodiments, a gasket may be configured to attach to a side of a door jamb or a side of a door. The gasket may comprise a foam portion comprising an intumescent material configured to expand when exposed to a temperature above a threshold temperature. The foam portion may comprise a base surface configured to contact one of the side of the door jamb or the side of the door, and at least one fin configured to contact the other of the side of the door jamb or the side of the door when the door is closed to at least partially seal a gap between the side of the door jamb and the side of the door when the door is closed. The foam portion may be configured to resist intrusion of smoke and water between the gap when the foam portion is unexpanded. The foam portion may be configured to resist intrusion of fire, smoke, and water when the foam portion is expanded.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 shows a perspective section view of a gasket configured to resist infiltration from smoke, fire, and water according to an embodiment;

FIG. 2 shows a schematic cross-sectional view of the gasket according to the embodiment of FIG. 1 taken along section line 2-2;

FIG. 3A shows a schematic representation of the gasket of FIG. 1 in an unexpanded state attached between a door and a door jamb;

FIG. 3B shows a schematic representation of the gasket of FIG. 1 in an expanded state attached between a door and a door jamb; and

FIG. 4 shows a flowchart detailing a method of manufacture for forming a gasket configured to resist infiltration from smoke, fire, and water.

### DETAILED DESCRIPTION

As discussed above, establishing a seal around doors to create an effective barrier to smoke, fire, and water infiltration may be desirable. For instance, such a configuration may be desirable on a safe door to help protect contents stored inside a safe. Many safes are fire-resistant, such that an amount of heat transferred into the interior of the safe through the safe walls may be limited. For additional protection against smoke and fire damage, safes may have an intumescent gasket around a perimeter of the door to restrict infiltration of smoke and fire through gaps between a door and a door jamb.

Many safe owners wish to protect the contents of their safe against potential damage due to water infiltration in addition to smoke and fire, such as during a flood. It may also be desirable to resist moisture entering the safe to avoid fouling due to mildew, mold, etc. of contents stored inside the safe. Such arrangements conventionally require using a water-resistant gasket. To achieve an effective barrier to smoke, fire, and water infiltration around the safe door, conventional safes generally utilize a first intumescent gasket configured to at least partially limit fire and smoke infiltration and a second gasket configured to at least partially limit water infiltration. Limiting infiltration of fire, smoke, and water may help limit damage to items stored inside the safe.

The inventors have appreciated that using more than one gasket to resist infiltration due to smoke, fire, and water presents challenges for safe manufacturers and safe owners. Conventional arrangements require procuring separate gaskets which can increase cost to manufacture. Installation time may also increase due to the need to install two separate gaskets. Additionally, installing more than one gasket may be difficult due to constraints imposed by dimensions of the safe.

The inventors have therefore recognized the benefits of a single gasket at least partially formed of an intumescent material configured to at least partially seal gaps around safe doors and resist infiltration (intrusion) of smoke, fire, and water into the interior of the safe. Such a gasket may reduce the need to install multiple gaskets to protect contents of the safe from smoke, fire, and water infiltration. A single gasket may also reduce manufacturing costs and increase ease of installation. Additionally, a single gasket may make it possible to retrofit an existing safe to protect contents from water, fire, and smoke damage in situations where dimensions around a safe door prevent the installation of two separate gaskets.

The inventors have recognized that a single gasket can be installed to seal a gap between a side of a door jamb and a side of a door to protect contents of the safe from damage due to smoke, fire, and/or water. At least a portion of the gasket comprises an intumescent foam. The intumescent foam may be configured to resist water and smoke infiltration in an unexpanded state and to additionally resist fire infiltration in an expanded state. When installed, a bottom surface of the gasket attaches to the side of the door jamb such that the intumescent foam portion directly contacts each side of the gap. In some embodiments, the foam portion may comprise a top surface configured to contact the side of the door and at least partially seal the gap. In some embodiments, the foam portion may comprise at least one fin configured to contact the side of the door to at least partially seal the gap. In some embodiments, the foam portion may comprise a plurality of fins configured to contact the side of the door to at least partially seal the gap.

With the door in a closed configuration, the top of the gasket contacts the side of the door such that there is contact between the intumescent foam and each side of the gap between the door and the door jamb. When the gasket is in an unexpanded state, direct contact between the intumescent foam and each side of the gap may create at least a partial seal to resist infiltration due to water. Additionally or alternatively, the at least partial seal may create a smoke-resistant seal. If a threshold temperature is met, the intumescent foam expands within the gap. In the expanded state, the intumescent foam maintains contact with each side of the gap between the door and the door jamb such that the gasket may form a fire-resistant seal in addition to the water-resistant and smoke-resistant seal. As discussed later in further detail, it should be appreciated that the gasket may be installed along any portion of a perimeter of the door to at least partially seal around the entire door.

The inventors have also recognized that the gasket may be formed through a method comprising extrusion. In some embodiments, extrusion may comprise coextrusion. The gasket may comprise an intermediate portion on which an adhesive is applied. In some embodiments, the intermediate portion comprises a plastic strip. The inventors have recognized that it may be beneficial to form the foam portion and the intermediate portion integrally.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

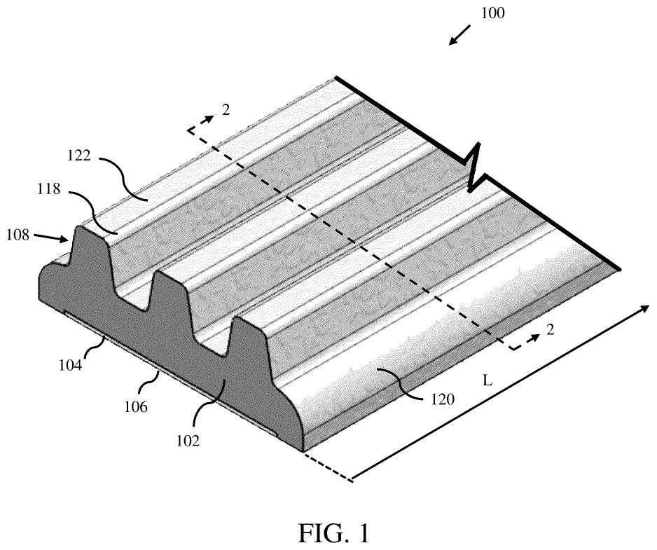

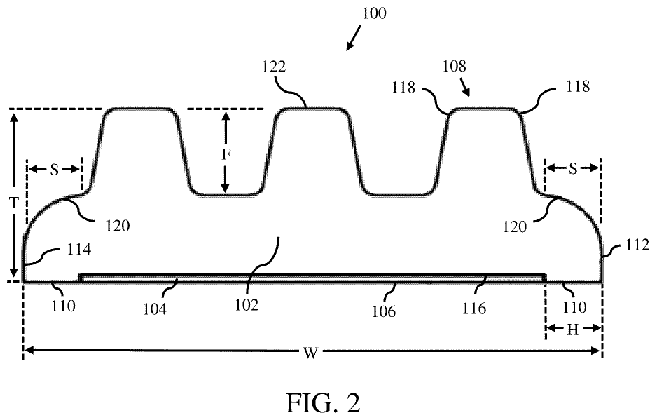

FIG. 1 shows a perspective view of a portion of a gasket 100 configured to attach to a door jamb and resist infiltration of smoke, fire, and water into an interior of a safe according to an embodiment, and FIG. 2 shows a schematic cross-sectional view of the gasket 100 according to the embodiment of FIG. 1.

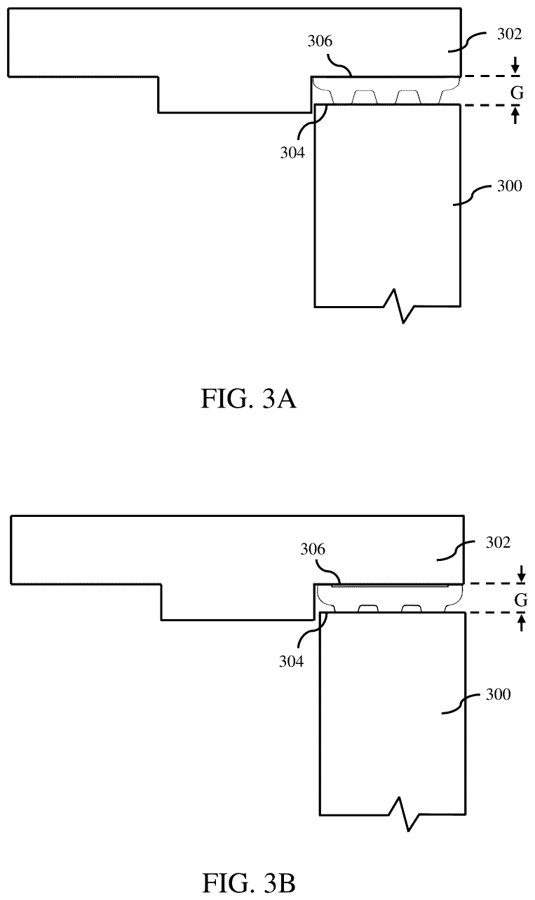

In some embodiments, the gasket 100 comprises a foam portion 102 comprising an intumescent foam configured to expand when exposed to an ambient temperature greater than a threshold temperature. In some embodiments, the foam portion 102 comprises a base surface 110 configured to contact a support surface when the gasket 100 is installed. As described in more detail later with reference to FIGS. 3A-3B, direct contact between the foam portion 102 and the support surface may establish a seal resistant to water and/or smoke infiltration. Additionally, the intumescent foam itself may possess water-resistant characteristics, such that water is at least limited from passing through the foam portion 102. The ability of the foam portion 102 to expand if exposed to an ambient temperature greater than a threshold temperature may cause the gasket 100 to at least partially seal against fire infiltration when installed. In the depicted embodiment, an intumescent foam is contemplated, however it should be appreciated that any suitable intumescent material may be used as the disclosure is not so limited.

In some embodiments, the gasket 100 comprises an adhesive 106 configured to attach the gasket 100 to a support surface. Depending on the material properties of the intumescent foam (e.g., an amount of plasticizer), adhesives may not adequately bond to the foam portion 102 of the gasket 100. In such situations, the adhesive 106 may initially attach to the foam portion 102, but then detach relatively quickly. In this regard, the inventors recognized that in some embodiments it may be beneficial for the gasket 100 to comprise an intermediate portion 104 that is formed of a different material than the foam portion 102 of the gasket 100. Properties of such an intermediate portion may have more desirable bonding characteristics compared to the intumescent foam (e.g., less plasticizer). The intermediate portion 104 may be attached to the foam portion 102 adjacent to the base surface 110 such that the intermediate portion 104 forms at least a portion of a bottom of the gasket 100 (e.g., a strip of rigid plastic or other rigid material which extends along a length of the gasket 100 and forms at least a portion of a bottom surface of the gasket 100). In some embodiments, the intermediate portion 104 may be formed of a rigid plastic. In some embodiments, the intermediate portion 104 may be formed of a polyvinyl chloride (PVC) material, although any suitable rigid plastic material may be used.

In some embodiments, the foam portion 102 and the intermediate portion 104 are formed as an integrally formed member. An integrally formed member may exhibit superior mechanical qualities compared to gaskets requiring two joined members. In some embodiments, the integrally formed member may be formed through extrusion. Any suitable means of extrusion may be utilized such as extruding the foam portion 102 and intermediate portion 104 at a pre-determined temperature and subsequently cooling the integrally formed member using any appropriate means (e.g., air cooling, water cooling, etc.). Integrally forming the intermediate portion 104 and the foam portion 102 using extrusion may be beneficial to ensure that the intermediate portion 104 is permanently attached via a mechanical bond to the foam portion 102. Extrusion may therefore be beneficial to mitigate against the intermediate portion 104 detaching from the foam portion 102 in the same manner as the adhesive. In some embodiments, extrusion may comprise coextruding the foam portion 102 and the intermediate portion 104 using any suitable means of coextrusion.

In some embodiments, gasket 100 may comprise a length L. The length of the gasket may correspond to standard dimensions of a door, a window, a safe door, etc. to reduce or eliminate the need to modify the length prior to installation. In some embodiments, the gasket 100 may be manufactured in relatively longer sections which can be cut down to length as desired. In some embodiments, intermediate portion 104 is attached to the bottom of gasket 100 along the entire length L. Such a configuration may be beneficial to allow the gasket 100 to be continuously attached to the support surface along length L. Continuous attachment may provide a more secure installation and may reduce a likelihood that the gasket 100 separates from the support surface.

As described above, the adhesive 106 may be disposed on the intermediate portion 104 such that the gasket 100 is configured to attach to a support surface via the adhesive 106. The adhesive 106 may be beneficial for attaching the gasket 100 to a support surface for a variety of reasons. First, the adhesive 106 may reduce the need for tools during installation. Additionally, the adhesive 106 may decrease possible damage to a support surface compared to a mechanical fastener (screws, bolts, staples, etc.). It is appreciated that the adhesive 106 may comprise any suitable adhesive, for example a glue, an adhesive film, a double-sided tape, etc. Additionally or alternatively, it is contemplated that in some embodiments mechanical fasteners (e.g., screws, staples, nails, etc.) may be desirable to secure the gasket 100 to a support surface. Mechanical fasteners may allow for a more permanent installation of the gasket 100. Such an installation may be desirable for vandal resistance and/or to reduce a likelihood that the installation of the gasket 100 is compromised due to wear.

In the unexpanded state, the gasket 100 may have a thickness T of 5/32 inch. In some embodiments, thickness T may be any suitable thickness between or equal to 1 inch and ⅛ inch, such as 1 inch, ¾ inch, ½ inch, ⅜ inch, ¼ inch, ⅛ inch, or other desired thickness. However, it is contemplated that the gasket 100 may have any suitable thickness in the unexpanded state such that the gasket 100 at least partially seals a gap G around a door against smoke and/or water infiltration, as the disclosure is not so limited. Additionally, it is contemplated that gasket 100 may have any suitable width W such that the gasket 100 can be installed on a door jamb and provide at least a partial seal against infiltration due to smoke and water in the unexpanded state and additionally against fire in the expanded state. In some embodiments, the width W may be any suitable width between or equal to 6 inches and ½ inch such as, 6 inches, 4 inches, 3 inches, 2 inches, 1-½ inches, 1 inch, ½ inch, or other desired width. It may be desirable for the gasket 100 to have a width such that the gasket decreases interference with a door during a closing operation. For example, some safe doors and door jambs may have geometry suited to accept a gasket of a specific width. In some embodiments, a relatively smaller width may be beneficial to allow a gasket to be installed where there are spatial constraints. In some embodiments, a relatively larger width W may be beneficial to increase fire-resistant, water-resistant, and/or smoke-resistant characteristics of the gasket 100. For example, an increased width W may allow for more contact between the foam portion 102 and the support surface and/or the side of the door.

In some embodiments, the foam portion 102 may comprise a recessed portion 116 (See FIG. 2). The recessed portion 116 may be formed adjacent to the base surface 110. Intermediate portion 104 and the adhesive 106 may be disposed within recessed portion 116. Such a configuration may be beneficial because in some embodiments the adhesive 106 may be configured to be coplanar with the base surface 110. A coplanar configuration may be beneficial to the water and/or smoke-resistant qualities of the gasket 100 by facilitating direct contact between the support surface and the foam portion 102 along the base surface 110. Direct contact between the foam portion 102 and the support surface may resist water infiltrating between the gasket 100 and the support surface. This may mitigate the likelihood of water compromising the adhesive 106 and/or the attachment of the gasket 100 to the support surface. Direct contact between the foam portion 102 and the support surface may also mitigate the likelihood of smoke infiltrating between the gasket and the support surface.

FIG. 3A shows a schematic representation of the gasket of FIG. 1 in the unexpanded state attached between a door 300 and a door jamb 302 of a safe. FIG. 3B shows a schematic representation of the gasket of FIG. 1 in the expanded state attached between the door 300 and the door jamb 302 of a safe. With the door 300 in a closed configuration, a door side 304 may be substantially parallel to a door jamb 302, and separated by a gap G. It is contemplated that the door side 304 may be any side of the door 300, such as a hinge side, a latch side, a header side, or a threshold side. It is contemplated that the door jamb 302 may be any door jamb such as a header-side jamb, a threshold-side jamb, a hinge-side jamb, or a latch-side jamb. Additionally, it is contemplated that the gasket 100 is not limited to installations on safes. The gasket 100 may be installed on door jambs for any door where resistance to smoke, water, and/or fire infiltration is desired. It is also contemplated that the gasket 100 may be installed around windows where smoke, water, and/or fire resistance is desired.

In some embodiments, the gasket 100 is attached to a support surface 306 of a door jamb 302 via the adhesive 106. In some embodiments, the support surface 306 is cleaned, sanded, or otherwise prepared prior to attachment of the adhesive 106, in order to achieve proper adhesion. Once attached, the foam portion 102 directly contacts the support surface 306 along the base surface 110. A top portion of the gasket 100 may contact the door side 304 such that with the door 300 in a closed configuration, the gasket 100 may at least partially seal the gap G around the door. Due to the direct contact between the foam portion 102 and each side of the gap G, the gasket 100 may create a barrier to the infiltration of smoke and/or water when the gasket 100 is in the unexpanded state.

As discussed previously, in some embodiments, the foam portion 102 directly contacts the support surface 306 along the base surface 110 when the gasket 100 is secured to the support surface. This direct contact may limit smoke and/or water from flowing through gaps between the door 300 and the door jamb 302 when the gasket 100 is in the unexpanded state and/or in the expanded state. In some embodiments, the foam portion 102 overhangs the intermediate portion 104 and/or the adhesive 106 such that the base surface 110 directly contacts the support surface 306. The foam portion 102 may overhang the intermediate portion 104 and/or the adhesive 106 adjacent to a first side 112. Additionally or alternatively, the foam portion 102 may overhang the intermediate portion 104 and/or adhesive 106 adjacent to a second side 114 opposite the first side. The extent of this overhang may be characterized by width H (See FIG. 2). In some embodiments, width H may be between or equal to 1 inch and 1/64, such as 1 inch, ¾ inch, ½ inch, ¼ inch, ⅛ inch, 1/16 inch, 1/32, or 1/64 inch, or any other appropriate size. In some embodiments, width H may be 3/64 inch. A relatively larger width H may increase the water-resistant and/or smoke-resistant characteristics of the gasket 100 by increasing a contact area between the foam portion 102 and the support surface 306. Additionally or alternatively, a relatively larger width H may increase the fire-resistant characteristics of gasket 100.

Returning to FIG. 2, in some embodiments, the gasket 100 comprises at least a fin 108 extending from the top of gasket 100. The fin 108 may be beneficial to increasing the smoke-resistant, water-resistant, and/or fire-resistant characteristics of the gasket 100. Compression of the fin 108 when the door is in a closed configuration may contribute to at least partially sealing gap G. The fin 108 may have a fin height F of between or equal to 1 inch and 1/16 inch, such as 1 inch, ¾ inch, ½ inch, ¼ inch, ⅛ inch, 3/32 inch, or other appropriate height. In some embodiments, the fin height F may be 5/64 inch. It should be appreciated that the fin height F may be any appropriate height such that the gasket 100 may at least partially seal the gap G. It is appreciated that different fin heights may be desirable depending on a specific application. For example, a relatively small gap may be partially sealed by the gasket 100 comprising one or more fins having a relatively small fin height. Additionally or alternatively, a relatively small fin height may be desirable to reduce interference during a door opening or door closing operation. A relatively larger fin height may produce beneficial sealing characteristics through a relatively larger gap G. In some embodiments, the fin 108 comprises a tapered shape. The tapered shape may be beneficial to distribute load during door opening and closing operation as well as when the gasket is compressed between the door side 304 and the support surface 306. A decreased contact area between a top portion 122 of the fin and the side of the door 300 due to the tapered shape may reduce shear during door operation. This could reduce a likelihood that door operation peels the gasket 100 from the support surface 306. In some embodiments, the fin 108 comprises at least an edge 118 adjacent to the top portion 122 of the fin. In some embodiments, edges 118 comprise a rounded shape. The rounded shape of the edges may be beneficial to decrease stress concentrations along a surface of the fin 108 and in turn may increase a lifespan of the gasket 100. In some embodiments, the top portion 122 of fin 108 comprises a rounded shape.

In some embodiments, the gasket 100 comprises a plurality of fins 108. An increased number of fins 108 may improve smoke, water, and/or fire-resistant characteristics of the seal in the unexpanded and/or expanded states. In some embodiments, each of the plurality of fins 108 has an equal height. In some embodiments, each of the plurality of fins 108 may have unequal heights. In some embodiments, some fins 108 may have a first height, and some other fins 108 have may have a second height. Unequal heights may provide a desired clearance to reduce potential interference between the gasket 100 and the door 300 during door operation. The fins 108 of the gasket 100 may improve door opening and closing operations due to the decreased friction of the fins 108 contacting the door side 304 compared to a continuous top surface of the gasket 100. Additionally, the decreased friction may reduce shear stress acting on the base of the gasket 100 during door opening and closing. This may in turn reduce the likelihood that the gasket 100 is peeled from the support surface. When the door 300 is in a closed configuration, the door side 304 may compress the fins 108. Such compression may improve the sealing of the gap G and may improve the water, smoke, and/or fire-resistant characteristics of the gasket 100. A tight seal may also be beneficial to resisting moisture intrusion into a safe, such moisture intrusion known to cause fouling due to mold, mildew, rust, etc.

In some embodiments, the gasket 100 comprises at least an offset region 120 within which no fin exists. In some embodiments, the gasket 100 may comprise offset region directly adjacent to the first side 112. Additionally or alternatively, the gasket 100 may comprise an offset region 120 adjacent to the second side 114 opposite the first side 112. In some embodiments, the offset region 120 may comprise an offset dimension S. In some embodiments, the offset dimension S can be measured from the first side 112 and/or from the second side 114 such that no fins exist within offset regions 120. The absence of the fins 108 within the offset region may decrease interference between the fins and door 300 during door operation. In some embodiments, the offset dimension S may be between or equal to ½ inch and 1/64 inch, such as 1/64 inch, 1/32 inch, 1/16 inch, ⅛ inch, ¼ inch, ½ inch or other offset dimension. In some embodiments, the offset dimension S may be equal to 3/64 inch. It is contemplated that a relatively larger offset region associated with a relatively larger offset dimension S may be beneficial to reduce interference between the gasket 100 and the door 300 during door operation. Additionally, it is contemplated that a relatively smaller offset dimension S may be beneficial to include more fins to maintain a desired seal. In some embodiments, the foam portion 102 comprises a rounded shape within the offset region 120. Such a rounded shape may reduce interference between the door 300 and the gasket 100 during door operation. The rounded shape may also reduce stress concentrations experienced by the foam portion within the offset region S which may increase the lifespan of the gasket 100. Additionally, a rounded shape may be beneficial to mitigate against a door catching an edge that may otherwise exist within the offset region 120.

In some embodiments, the gasket 100 resists fire intrusion through gaps around the door 300 in an expanded state. In some embodiments, the gasket 100 resists water and/or smoke intrusion in addition to fire intrusion in the expanded state. If a threshold ambient temperature is reached, the foam portion 102 expands to further fill gap G. In some embodiments the threshold temperature may be greater than or equal to 300° F. In some embodiments, the threshold temperature may be equal to 390° F. When expanded, the gasket 100 seals the door 300 in place and resists infiltration of fire into the safe while maintaining its resistance to smoke and water infiltrating around the door through the gap G. The ability for the gasket 100 to maintain its water-resistant and smoke-resistant characteristics during the expanded state is beneficial, for example, during a potential fire-fighting situation where water may be used to extinguish a fire. In addition to protecting contents stored inside the safe from damage due to smoke and fire, the gasket 100 may also act to protect the contents from possible water damage. Up to this point, this disclosure has described the water-resistant and smoke-resistant characteristics of the gasket 100. It should be appreciated that the gasket 100 may seal the gap G and resist infiltration of other fluids through the gap G in a similar manner as the disclosure is not so limited.

While the above embodiments disclose the gasket 100 attached to a side of a door jamb, it is contemplated that the gasket 100 according to embodiments disclosed herein may instead be attached to a side of a door as the disclosure is not so limited. Additionally, while the above statements discuss the gasket 100 installed on doors, the disclosure is not so limited. Indeed, the inventors have recognized such a gasket may be used on any door, hatch, window, fenestration, etc. where smoke, fire, and/or water resistance is desired. For example, such a gasket may be used on ships, storm doors, building doors, windows, skylights, etc., as the disclosure is not so limited. The inventors have also recognized that the gasket may be installed on containers, covers to containers, enclosures, covers to enclosures, compartments, covers to compartments, battery boxes, and/or any product where resistance against smoke, water, and/or fire is desired as the disclosure is not so limited.

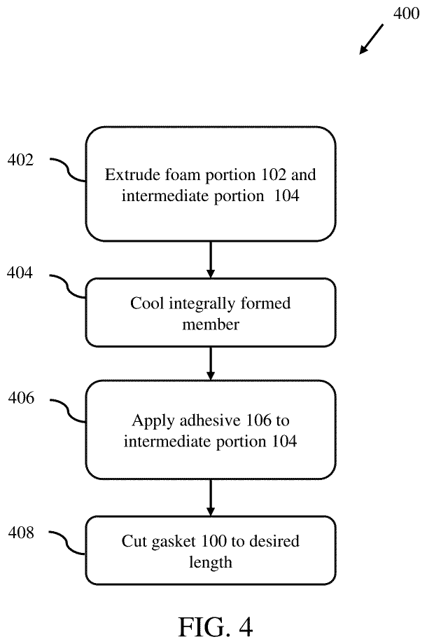

FIG. 4 shows a flowchart detailing a method of manufacture 400 for forming gasket 100. At 402, the foam portion 102 and the intermediate portion 104 are extruded using any conventional means to produce an integrally formed member. The intermediate portion 104 may comprise a different material than the foam portion 102 of the gasket 100. In some embodiments, the intermediate material may comprise a rigid plastic. In some embodiments, the intermediate material may comprise a polyvinyl chloride (PVC) material. As discussed previously, an integrally formed member may exhibit superior characteristics compared to a gasket formed of two separate members that have been joined together. For example, two separately formed members may be prone to separation after prolonged use which may compromise the gasket 100. At 404, the integrally formed member is cooled using any conventional means (e.g., water cooling, air cooling, etc.). At 406, the adhesive 106 is applied to the intermediate portion 104, forming the gasket 100. At 408, the gasket 100 is cut to a desired length. In some embodiments, the desired length may substantially equal a dimension of a safe door (e.g., door width, door height, etc.). In some embodiments, the desired length may be a length suitable for shipping the gasket 100. In some embodiments, the desired length may be a length suitable for storing the gasket (e.g., in a distribution center, warehouse, retail outlet, etc.). Cutting the gasket 100 into desired lengths associated with a standard safe dimension may increase ease of installation of the gasket 100 for a particular safe (e.g., a specific model, a specific brand, a specific storage size, etc.).

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A gasket configured to attach to a side of a door jamb or a side of a door, the gasket comprising:
a foam portion comprising an intumescent material configured to expand when exposed to a temperature above a threshold temperature, the foam portion comprising a base surface configured to contact one of the side of the door jamb or the side of the door and at least one fin configured to contact the other of the side of the door jamb or the side of the door when the door is closed to at least partially seal a gap between the side of the door jamb and the side of the door when the door is closed, the foam portion configured to resist intrusion of smoke and water through the gap when the foam portion is unexpanded, the foam portion further configured to resist intrusion of fire, smoke, and water when the foam portion is expanded;
an intermediate portion attached to the foam portion adjacent to the base surface, the intermediate portion formed of a different material than the foam portion; and
an adhesive applied to the intermediate portion and configured to attach the gasket to the side of the door jamb or the side of the door.

2. The gasket of claim 1, wherein the intermediate portion is a rigid plastic strip.

3. The gasket of claim 2, wherein the rigid plastic strip and the foam portion are integrally formed through coextrusion.

4. The gasket of claim 3, wherein the foam portion comprises a plurality of fins configured to at least partially seal the gap when the intumescent material is unexpanded.

5. The gasket of claim 4, wherein the plurality of fins are offset from a first side of the gasket.

6. The gasket of claim 5, wherein the plurality of fins is offset from a second side of the gasket opposite the first side.

7. The gasket of claim 6, wherein each of the plurality of fins has an equal height.

8. The gasket of claim 7, wherein each fin comprises at least one edge adjacent to a top portion of each fin, and wherein each edge comprises a rounded shape.

9. The gasket of claim 8, wherein the rigid plastic strip comprises a polyvinyl chloride (PVC) material.

10. The gasket of claim 9, wherein the door jamb is a door jamb of a safe.

11. The gasket of claim 10, wherein the foam portion comprises a recessed portion adjacent to the base surface, and wherein the rigid plastic strip and the adhesive are disposed in the recessed portion.

12. The gasket of claim 11, wherein the adhesive is coplanar with the base surface.

13. The gasket of claim 12, wherein the foam portion comprises a rounded shape within an offset region.

14. The gasket of claim 13, wherein each fin comprises a tapered shape.

15. The gasket of claim 14, wherein the foam portion overhangs the intermediate portion and/or adhesive adjacent to the first side.

16. The gasket of claim 15, wherein the foam portion overhangs the intermediate portion and/or adhesive adjacent to the second side.

17. A gasket configured to attach to a side of a door jamb or a side of a door, the gasket comprising:
a foam portion comprising an intumescent material configured to expand when exposed to a temperature above a threshold temperature, the foam portion comprising:
a base surface configured to contact one of the side of the door jamb or the side of the door; and
at least one fin configured to contact the other of the side of the door jamb or the side of the door when the door is closed to at least partially seal a gap between the side of the door jamb and the side of the door when the door is closed,
wherein the foam portion is configured to resist intrusion of smoke and water between the gap when the foam portion is unexpanded, and
wherein the foam portion is configured to resist intrusion of fire, smoke, and water when the foam portion is expanded.

18. The gasket of claim 17, wherein the foam portion comprises a plurality of fins configured to at least partially seal the gap when the intumescent material is unexpanded.

19. The gasket of claim 18, wherein the foam portion comprises a first offset region adjacent to a first side of the gasket, wherein the gasket comprises the plurality of fins outside the first offset region.

20. The gasket of claim 19, wherein the gasket further comprises a second offset region adjacent to a second side of the gasket opposite the first side, wherein the gasket comprises the plurality of fins outside the first offset region and the second offset region.
